(19) United States
(12) Patent Application Publication
(10) Pub. No.: US 2023/0012017 A1
(43) Pub. Date: Jan. 12, 2023

(54) TUBULAR ELECTROCHEMICAL SEPARATION UNIT AND MANUFACTURING METHOD THEREFOR

(71) Applicant: TotalEnergies OneTech, Courbevoie (FR)

(72) Inventor: Loïc Francke, Pau Cedex (FR)

(21) Appl. No.: 17/783,191

(22) PCT Filed: Dec. 20, 2019
(86) PCT No.: PCT/IB2019/001465

§ 371 Date: Jun. 7, 2022

(51) Int. Cl. B01D 63/06; B01D 61/46; B01D 61/42

(52) U.S. Cl. CPC B01D 63/061; B01D 61/46; B01D 61/423; B01D 63/062; B01D 2313/345

(57) ABSTRACT

The invention relates to a method for producing a tubular electrochemical separation unit comprising a plurality of electrochemical cells, arranged electrically in series, and comprising at least three layers, said method comprising: —a deposition step (110) of a first layer to form a first discontinuous layer (10) comprising several successive tubular modules (11) separated by spaces (12), —a deposition step (120) of a second layer, said deposition being achieved to form a second discontinuous layer (20) comprising several successive tubular modules (21) separated by spaces (22), so that tubular modules (11) are partially coated with tubular modules (21) of the second layer (20), —a deposition step (130) of a third layer, said deposition being achieved to form a third discontinuous layer (30) comprising several successive tubular modules (31) separated by spaces (32), so that tubular modules (21) are partially coated with tubular modules of the third discontinuous layer.

### FIELD OF THE INVENTION

The present invention relates to the field of membrane separation processes. In particular, the invention relates to the field of electrochemical separation membranes. This invention provides a new method for producing a tubular electrochemical separation unit, a new tubular electrochemical separation unit, and a system for producing a tubular electrochemical separation unit.

### BACKGROUND

There has been for many years an ongoing effort to develop new and improved separation membranes for selective separation. Separation membrane technologies cover different approaches and apply, generally, to the separation of substances between two fractions. Separation membranes allow to stop the passage of or allow a selective passage of some substances dissolved in a mixture. The separation is done under the action of a driving force of transfer according to a defined separation mechanism (the pressure difference, the gravitational force, the centrifugal force, the temperature difference, the difference in concentration, the difference in electrical voltage). More specifically, in an electrochemical membrane separation, an electrochemical potential gradient provides the driving force across the membrane which is established by applying an external potential. Separation membranes are defined by several characteristics and parameters like permeability and selectivity.

Several examples of separation using separation membranes already exist, such as filtration: sieving, microfiltration, ultrafiltration, nano-filtration, pervaporation, osmosis and reverse osmosis.

Electrochemical membrane separation methods offer many advantages, such as being compact and allowing modular installations, continuous extraction or production, high selectivity, short time of separation.

For these reasons, separation membranes have been developed in different field of applications like purification, concentration, fractionation, degassing of liquids, water treatments, analysis techniques and energy production particularly with fuel cells and gas separation or production.

With these developments, production of membranes has risen sharply, specifically in the technical field of energy production, where separation membranes play an important role.

Typically, molecules are separated by capillary forces through a more or less porous membrane. However, time needed for separation of molecules is generally important, inducing a low efficiency.

In this context, utilization of electrochemistry has been developed to reduce the time of separation by providing energy to accelerate separation processes and allowing mass production.

Further improvements have been obtained by adding electro-conductive particles, polymeric binders and, in particular materials capable of favoring the migration of protons or some ions.

However, notwithstanding these improvements and implementations, the design of ion exchange membranes has not given so far a satisfactory reply to the problems of safety and fabrication costs, bound to the types of materials used for the construction, as well as to the need for a mass production and the assembling simplicity.

Typically, mixture of gas or liquid are fed into an inlet of compartment comprising the separation membrane, an electrical current is applied to improve the separation (conversion) of molecule into ions and their selective transport to the anode or the cathode trough the selective ion exchange membrane.

To produce an electrochemical separation unit, the document EP0629015 teaches a assemblies of cell elements, each of said cell elements comprises a unitary electrodes-membrane structure rigidly pressed between the two sides of the two adjacent bipolar plates. In particular, EP0629015 teaches cell elements comprising a pair of bipolar or end plates provided with holes for feeding the gaseous reactants and removing the products and the residual reactants. The cell elements also comprise a pair of electrocatalytic porous electrodes, an ion exchange membrane and a pair of gasket-frames. The pair of gasket-frame includes a multiplicity of points for the electrical contact between said bipolar or end plates and said electrodes. These assemblies, having a serial connection, need sealing and peripheral sealing to obtain an electrically connection between each electrochemical cell and to form the electrochemical unit. These assemblies increase the costs of production (more steps of the method for producing, more elements, more components, more means and more resources) and decrease the safety, each point of connection inducing a risk of failure.

Electrochemical membranes require the application of an electrical potential on both sides of the membrane to effect migration of the molecule within this membrane. However, due to the specific electrical resistance of the electrochemical layer, it is mandatory to limit the size of cells, even though long length cells would be desirable to allow mass production. To obtain long devices using an electrochemical separation, it is then necessary to arrange these different cells in series, electrically, making use of electrical insulators and conductive materials. An example of this prior art is illustrated on the first FIG. 1.

The electrochemical cells A, B, C, D of the electrochemical unit comprise three layers stacked on top of each of them. The first layer 1 corresponding to the internal electrode, the second layer 2 corresponds to electrochemical layer, for example for the separation and the transport of ion, and the third layer 3 corresponding to the external layer. Between each cell of the electrochemical unit, several electrical insulators 4a and conductive materials 4b, are used to connect each cell of the electrochemical unit in series. In addition, to increase the reliability and the tightness of junctions, welds 5 such as ceramic weld is implemented. The assembled electrochemical unit may have up to 4.7 million of ceramic welds.

Such a serial arrangement of electrochemical unit is then a cost source and source of failure at each of the connections between cells. Further, the risk of failure increasing with the number of cells arranged in series, such arrangements are not suitable to mass production.

Another way to improve electrochemical unit properties consists in working on the electrochemical unit composition: the anode composition, the cathode composition and the presence or not of intermediate layer and optional additives to confer specific properties to the electrochemical unit. Several documents disclose different compositions of each layer: EP10448613, WO2009/152255, EP3231501, WO2008/127406. Again, production costs are related to the components, for example using with noble metals is not recommended, especially since several residues accumulate into electrochemical cells.

Other example comprises mechanical compressor (in EP3245530) or electrochemical compressor which have been added to the structure of the electrochemical unit to improve the separation or the production. Indeed, the electrochemical units require the application of an electrical potential on both sides of the membrane to cause the migration of a molecule within this membrane.

However, these solutions still necessitate to use connections comprising insulating materials and conductive materials when considering arranging cells in serial connection to increase their length and thereby allowing mass production.

As mentioned above, these serials electrically arrangements constitute a cost source, are prone to dysfunction because of the numerous connections between each cells resulting in loss of energy, production, and also implying a safety risk in case of short circuit in the assemblage.

There is a need to reduce production costs of electrochemical unit, and for more reliable and robust said electrochemical unit, suitable their use for the separation of molecules of interest at an industrial level.

### Technical Problem

The invention aims to overcome the disadvantages of the prior art. In particular, the invention proposes a new method for producing a tubular electrochemical separation unit comprising several electrochemical cells, cells being electrically connected in series within said tubular electrochemical separation unit; said method being simpler to implement than the existing method of the art. It follows that costs of production are diminished. Further, the safety and robustness of resulting tubular electrochemical separation unit are greatly enhanced.

Also, the present disclosure is designed to provide a tubular electrochemical separation unit and a system for producing a tubular electrochemical separation unit.

### SUMMARY OF INVENTION

According to an aspect of the present invention, it is provided a method for producing a tubular electrochemical separation unit, said tubular electrochemical separation unit comprising a plurality of electrochemical cells arranged electrically in series, said tubular electrochemical separation unit comprising at least three layers, said method comprising:
A deposition step of a first layer, said deposition being achieved to form a first discontinuous layer, said first discontinuous layer comprising several successive tubular modules separated by spaces,
A deposition step of a second layer, said deposition being achieved to form a second discontinuous layer, said second discontinuous layer comprising several successive tubular modules separated by spaces, so that tubular modules of the first discontinuous layer are partially coated with tubular modules of the second discontinuous layer,
A deposition step of a third layer, said deposition being achieved to form a third discontinuous layer, said third discontinuous layer comprising several successive tubular modules separated by spaces, so that tubular modules of the second discontinuous layer are partially coated with tubular modules of the third discontinuous layer,
Said deposition steps resulting in the formation of electrochemical cells arranged electrically in series wherein a tubular module of the third discontinuous layer of an electrochemical cell is in contact with a tubular module of the first discontinuous layer of an adjacent electrochemical cell,
And wherein, a tubular module of the third discontinuous layer of the said electrochemical cell is also in contact with a tubular module of the second discontinuous layer of the said adjacent electrochemical cell.

According to other optional features of the method:
The deposition step of the second layer is achieved so that two successive tubular modules of the first discontinuous layer are partially coated with a tubular module of the second discontinuous layer. Whereas only one module of the first discontinuous layer can be partially coated with the tubular module of the second discontinuous layer, coating two adjacent modules of the first discontinuous layer with one module of the second discontinuous layer ensure that the access to the second electrode.
The deposition step of the third layer is achieved so that two successive tubular modules of the second discontinuous layer are partially coated with a tubular module of the third discontinuous layer. Whereas only one module of the second discontinuous layer can be partially coated with the tubular module of the third discontinuous layer, coating two adjacent modules of the second discontinuous layer with one module of the third discontinuous layer ensure that the access to the second electrode
The deposition step of the second layer is achieved so that a space between two successive tubular modules of the first discontinuous layer is filled with a tubular module of the second discontinuous layer. This allows an electrical separation between two successive tubular modules of the first layer and prevent gas leak out of this separation between two successive tubular modules of the first layer.
The deposition step of the third layer is achieved so that a space between two successive tubular modules of the second discontinuous layer is filled with a tubular module of the third discontinuous layer. This allows an electrical separation between two successive tubular modules of the second layer and prevent gas leak out of this separation between two successive tubular modules of the second layer.
the deposition process of layers is operated by successive steps in time and/or separate areas,
the deposition process of layers is selected from extrusion, co-extrusion, slip casting, injection molding, tape casting, spray coating, chemical vapor deposition, physical vapor deposition, doctor blade, atomic layer deposition, plasma-enhanced chemical vapor deposition, evaporation deposition, sputtering, molecular beam epitaxy, pulsed laser deposition, electrohydrodynamic, spin coating, bar coating, die coating, blade coating, air-knife coating, roll coating, gravure coating, dip coating, ink jet printing, screen printing, Langmuir-Blodgett, plasma-enhanced, electroless plating, thermal deposition, electroplating, spray deposition, sputter coating, e-beam evaporation, ion beam evaporation, spray pyrolysis.

According to another aspect of the present invention, it is provided a tubular electrochemical separation unit comprising a plurality of electrochemical cells arranged electrically in series, wherein said tubular electrochemical separation unit comprising at least three layers:
a first discontinuous layer, said first discontinuous layer comprising several successive tubular modules separated by spaces,
a second discontinuous layer, said second discontinuous layer comprising several successive tubular modules separated by spaces, arranged so that tubular modules of the first discontinuous layer are partially coated with tubular modules of the second discontinuous layer,
a third discontinuous layer, said third discontinuous layer comprising several successive tubular modules separated by spaces, arranged so that the second discontinuous layer comprises tubular modules partially coated with tubular modules of the third discontinuous layer,
   wherein said tubular electrochemical separation unit comprising several electrochemical cells arranged electrically in series, and wherein:
a tubular module of the third discontinuous layer of an electrochemical cell is in contact with a tubular module of the first discontinuous layer of an adjacent electrochemical cell, and
a tubular module of the third discontinuous layer of said electrochemical cell is also in contact with a tubular module of the second discontinuous layer of the said adjacent electrochemical cell;

According to other optional features of the tubular electrochemical separation unit:
said electrochemical cells within said tubular electrochemical separation unit are not separated by electrical insulators and/or conductive materials, and/or said electrochemical cells within said tubular electrochemical separation unit are not assembled by welding,
the contact between a tubular module of the third discontinuous layer of an electrochemical cell and a tubular module of the first discontinuous layer of an adjacent electrochemical cell is a direct contact,
said tubular electrochemical separation unit comprises at least two electrochemical cells, preferably at least five, more preferably at least ten.
a space between two successive tubular modules of the first discontinuous layer is filled with a tubular module of the second discontinuous layer,
a space between two successive tubular modules of the second discontinuous layer is filled with a tubular module of the third discontinuous layer,
the first discontinuous layer and the third discontinuous layer are electrodes,
the first discontinuous layer is an internal electrode,
the second discontinuous layer is an electrochemical separation membrane,
the third discontinuous layer is an external electrode;

According to another aspect of the present invention, it is provided a use of a tubular electrochemical separation unit according to the invention for electrochemical separation of molecular species.

According to another aspect, it is provided a system for producing a tubular electrochemical separation unit according to the invention, wherein said system comprises:
Means of transport configured to forward at least one layer, said means of transport being preferably arranged in order to be able to carry out a rotational movement
Means of deposition configured to achieve a tubular continuous or a tubular discontinuous deposit of each layer, and
Means for heating configured to heat each layer according to a predetermined and controlled time-temperature.

The invention will now be defined with references to the following non limiting examples and figures.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a schematic view showing an electrochemical unit according to prior art and comprising several connections with electrical insulators and conductive materials.

FIG. 2 is a schematic view showing an electrochemical cell according to prior art and comprising three layers.

FIG. 3 is a schematic view showing a tubular electrochemical separation unit according to an embodiment of the invention.

FIG. 4 is a schematic view showing an electrochemical cell according to an embodiment of the invention.

FIG. 5A is a schematic view showing the first and the second steps of a specific embodiment of a method for producing a tubular electrochemical separation unit according to the invention.

FIG. 5B is a schematic view showing the third step of a specific embodiment of a method for producing a tubular electrochemical separation unit according to the invention.

FIG. 6 is a schematic view of a system for producing a tubular electrochemical separation unit according to a first embodiment of the invention.

FIG. 7 is a schematic view of a system for producing a tubular electrochemical separation unit according to a second embodiment of the invention.

FIG. 8 is a global schematic view of a system for producing a tubular electrochemical separation unit according to the first embodiment of the invention.

### DETAILED DESCRIPTION

In the following description, “tubular” means, an elongated shape comprising a hollow, the elongated shape having the form or consisting of a tube, duct, conduit or pipe. It may have cross-sections of different shapes, but is preferably circular or cylindrical. It may vary in length, width and thickness and may be flexible or rigid, open at one extremity or two or not.

An «electrochemical cell» in the meaning of the invention comprises at least two electrodes (anode and cathode) and an electrochemical separation membrane. In a preferred embodiment, an electrochemical cell comprises three staged tubular modules from the first discontinuous layer, the second discontinuous layer and the third discontinuous layer respectively. More preferably and according to the invention two electrodes correspond to the first discontinuous layer and to the third discontinuous layer, even more preferably, the anode corresponds to the first discontinuous layer, and the cathode corresponds to the third discontinuous layer.

The word «unit» in the meaning of the invention corresponds to a single piece, or element or entity considered as forming an indivisible whole comprising complex arrangement. A unit according to the invention may consist to several electrochemical cells.

The expressions «electrically in series» or “series connection” or “serial connection” in the meaning of the invention correspond to an electrical assembly in series. The series connection corresponds to the connection of two or more components in a circuit so that they form a single current path. Two components are therefore connected in series, if their connection has no branch. The number of elements connected in series is arbitrary.

The word “electrochemical membrane” or “electrochemical separation membrane” may correspond according to the invention to a diaphragm, or all means or tools to separate at least two substances based on electrochemical process. Preferably, the membrane corresponds to a layer between at least to two electrodes (anode and cathode) and the electrochemical separation membrane may be a selective diaphragm separating ions and/or transporting ions between two volumes or compartments for electrochemical separation. More preferably and according to the invention, the electrochemical separation membrane corresponds to the second discontinuous layer.

The expression “discontinuous layer(s)” in the meaning of the invention, can correspond in successive tubular modules spaced from each other, and where space corresponds to empty zone between two successive tubular modules, said empty zone being arranged to be filled with a tubular module material from another discontinuous layer.

The word “adjacent” for example, when associated to two electrochemical cells, means that these cells share a common endpoint or border.

The expression “direct contact” describes a contact without intermediate between two elements, as for example the direct contact between the third and the first layers.

“Partially coated” in the meaning of the invention can correspond to a tubular module of a discontinuous layer whose surface is coated by a tubular module of another discontinuous layer at less than 100%, preferably less than 99.9% more preferably less than 99.5%. However, the surface of a tubular module of a discontinuous layer can be coated at more than 80% preferably more than 90%, more preferably more than 95%, even more preferably more than 98% by a tubular module of another discontinuous layer.

In the rest of the description, the same references are used to designate the same elements.

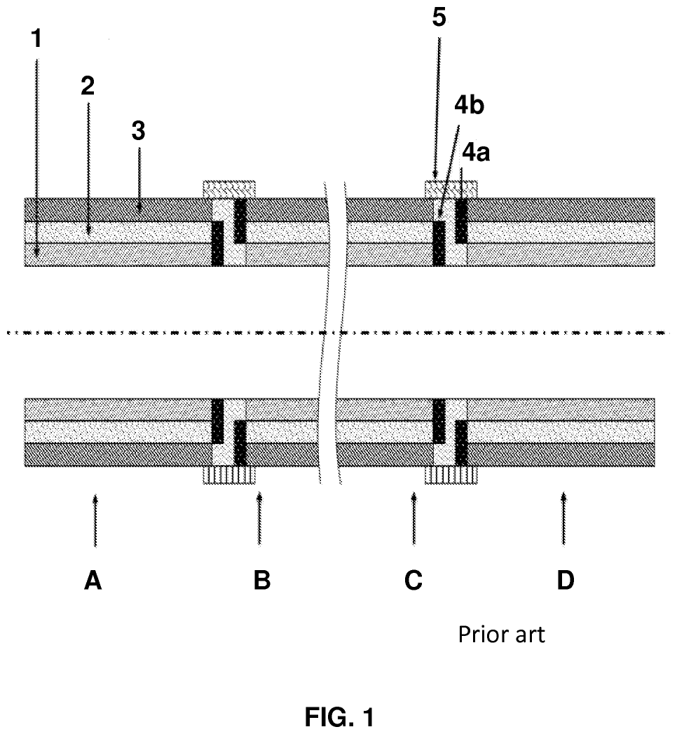

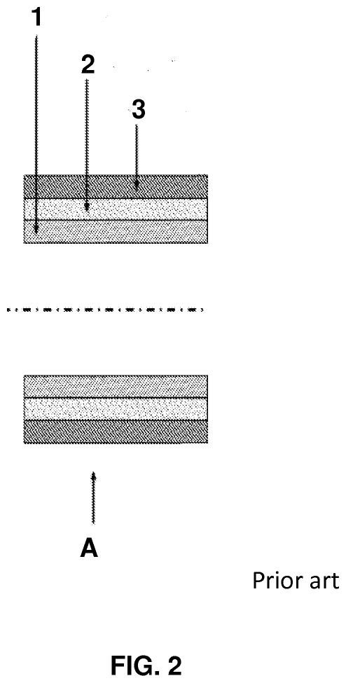

As explain below, the FIG. 1 shows a state of the art of a conventional serial-connected tubular electrochemical unit wherein electrochemical cells A, B, C, D comprise three layers 1, 2, 3 and wherein each cell is in serial electrical contact with the adjacent cell thanks to electrical insulator 4a and conductive materials 4b to obtain an electrical connection in series. A ceramic weld 5 is present to improve the tightness of the connection. The FIG. 2 shows a state of the art of a conventional electrochemical cell A comprising three layers 1,2,3. The first layer 1 is completely coated by the second layer 2 which is also completely coated by the third layer 3. Each layer of a same electrochemical cell has the same length such as illustrated on the FIG. 2. This arrangement requires electrical insulator 4a and conductive material 4b in order that the current crosses each cell.

However, this serial arrangement is expensive as implying numerous steps for producing and the use of several elements or components. Further such arrangement is also the source of failure and of safety risks (short circuit and leaks) at each of the connections between cells, which number decreases reliability of the device as the size of the arrangement increases. In other words, this embodiment does not comply with mass production requirements, because of being costly in energy and material, poorly reliable and rising safety issues.

The inventor has developed a method for producing a tubular electrochemical separation unit allowing to reduce costs of production and the risk of failure, and to improve the reliability. Indeed the tubular electrochemical separation unit of the invention is devoid of components as additive or electrical insulators and conductive materials at each point of connection between electrochemical cells, thereby allowing to design long tubular electrochemical separation units without the aforementioned drawbacks of the prior art, and particularly adapted to the mass production. The method for producing a tubular electrochemical separation unit allows an electrical assembly in series.

The invention will be described thereafter in the framework of electrochemical separation of gas, it should be considered that the invention is not limited to gas and separation. Tubular electrochemical separation unit of the invention could be implemented with various liquids or solids or plasmas and in numerous different technical fields as filtration, purification, gas production, fuel cells.

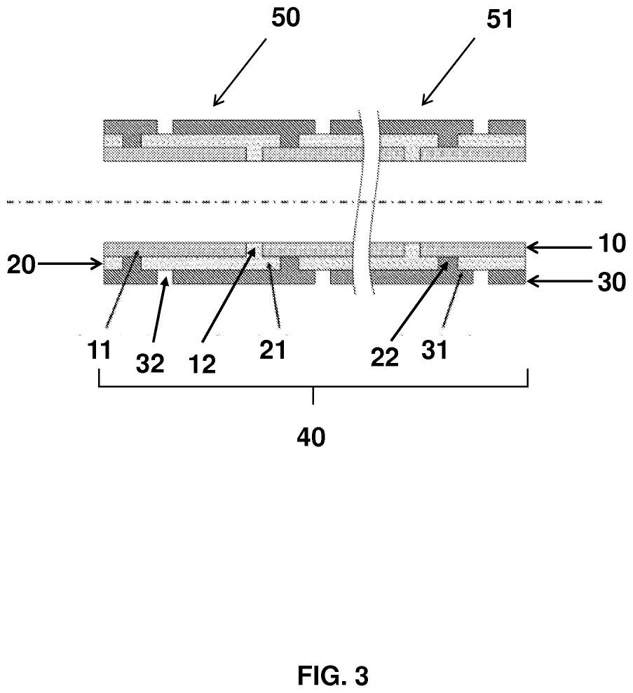

According to an aspect of the present invention, it is provided a tubular electrochemical separation unit 40 as illustrated in the FIG. 3.

The tubular electrochemical separation unit 40 comprises a plurality of electrochemical cells 50,51 arranged electrically in series, each electrochemical cell comprising at least three layers.

The electrochemical cells within said tubular electrochemical separation unit 40 are not separated by electrical insulators and/or conductive materials. Advantageously, in another embodiment, the electrochemical cells within said tubular electrochemical separation unit are not assembled by welding. Even more advantageously, electrochemical cells in said tubular electrochemical separation unit are not separated by electrical insulators and/or conductive materials and not assembled by welding. This allow to reduce costs of production and the risk of failure, and to improve the reliability, and allow to design long tubular electrochemical separation units particularly adapted to the mass production.

The tubular electrochemical separation unit 40 may comprise a first discontinuous layer 10. The first discontinuous layer 10 comprises several successive tubular modules 11 of the first layer separated by spaces 12. The first discontinuous layer 10 is a sequence of tubular modules 11 separated by a space 12 between each tubular module 11.

The first discontinuous layer 10 is, preferably, an internal electrode. Indeed, the electrochemical driving force for the transport across the tubular electrochemical separation unit, is the result of external voltage being applied, including the first discontinuous layer. Thus, the tubular electrochemical separation unit 40 is provided with electrode in order to separate, dissociate, the mixture introduced.

As an example, the first discontinuous layer 10 may be an anode. An anode may be a positive electrode, but the invention is not limited to this configuration and the internal electrode could be a negative electrode such a cathode There is no special limitation on the material to be used in the electrochemical separation unit of the invention providing that is electrically active for instance in an embodiment, an electrode may be manufactured by binding an electrode active material to a current generator by a typical method known in the art.

Thus, the first discontinuous layer 10 allows to an electrical current to pass through the tubular electrochemical separation unit 40.

In a preferred embodiment, gases flow through the first discontinuous layer 10, when said gases are injected in the tubular electrochemical separation unit 40.

The first discontinuous layer 10 comprises ceramics, conductive polymers, conductive materials that may be selected from, but not limited to: Ni, Fe, Pt, Pd, Ba, Sr, Y, Ca, Yb, Pr, Eu, Pr, In, Sc, Ce, Acc, O, Cu, Li, Al, Au, Ag, Acetylene, Acetylene black, carbon, carbon black or mixture of thereof, and salts of thereof, Poly(p-phenylene vinylene), Polyaniline, Poly(p-phenylene), Polypyrrole, Polythiophene, trans-Polyacetylene, ad doped mixtures of thereof.

Advantageously, the composition of the first discontinuous layer 10 is adapted to the mixture to be separated, in other words, the choice of material depends on the design, the desired activity and the compatibility with the tubular electrochemical separation unit.

Additionally, the first discontinuous layer 10 may comprise some optional additives such as pore formers, emulsifiers, binders, rheology modifiers, precursors of metal oxide, conductors. Optional additives allow to confer specific properties to the first discontinuous layer according to the mixture to be separated or to improve chemical reactions on its surface. Optional additives may be comprised between 0% and 10% of components as a whole of the first discontinuous layer 10.

Alternatively, the first discontinuous layer 10 is microporous, allowing gas diffusion, and molecules can pass through.

The first discontinuous layer 10 is made with known technologies in the art including but not be limited to: extrusion, co-extrusion, slip casting doctor-blade coating, spay-coating, physical vapor deposition, plasma enhanced chemical deposition, laminated. These deposition methods can be followed by sintering or co-firing improvement steps to modify material properties.

The first discontinuous layer 10 may present an ability to support/promote redox reactions of chemical species to generate ionic form that will migrate through the electrochemical separation unit. The first discontinuous layer 10 enables redox reaction of the desired transported molecules. The first discontinuous layer 10, preferably, allows to selectively oxidize or reduce molecules introduced with the mixture to be separated with a preferable redox selectivity for the desired molecule to be separated. Even more preferably, the first discontinuous layer allows to generate the ionic form of the molecule or mixture to be separated.

In addition, the first discontinuous layer 10 may present a pressure resistance comprises between 2 barg (for bar gauge pressure) and 900 barg, preferably between 10 barg and 450 barg, and more preferably between 20 barg and 100 barg. The first discontinuous layer 10 is adapted to different mixtures to be separated, and in particular to different technologies developing pressure as nano-filtration or reverse osmosis. Advantageously, the tubular form of the electrochemical separation unit allows a greater pressure resistance.

Furthermore, the first discontinuous layer 10 may present a temperature resistance comprises between 25° C. (for degrees Celsius) and 1000° C., preferably between 200° C. and 950° C. This is advantageous, especially when the dissociation or separation reactions are endothermic, but the first discontinuous layer 10 is also able to separate or dissociate heat sensitive components. The first discontinuous layer 10 allows heat management. Advantageously, Joule heating, also known as ohmic heating or resistive heating, is the process by which the passage of an electric current through a conductor releases heat. In the present invention, the ohmic loss during the operation of the separation unit will cause Joule heating. The heat generated in this process can be used to provide the heat required for the reforming process.

Advantageously, the first discontinuous layer 10 is stable even in chemically harsh conditions at high temperatures.

Moreover, the first discontinuous layer 10 may have an area specific resistance of 0.1 Ωcm² (for Ohm per square centimeter) to 2.0 Ωcm² such as 0.2 Ωper cm² to 1.5 Ωcm². The current density applied can be 100 mA/cm² (for milliampere per square centimeter) to 650 mA/cm², such as 250 mA/cm² to 500 mA/cm².

Advantageously, the first discontinuous layer 10 is composed of several successive tubular modules 11, as shown on the FIG. 3. The tubular module 11 is a part of the first layer. The first discontinuous layer 10 is a recurrence of a pattern as 11-12-11-12 where 11 is a tubular module or a part of the first layer and 12 is an area or space which is not filled with the material of the first layer (i.e. of tubular module 11). The pattern 11-12-11-12 allows to provide a discontinuous layer and more particularly the first discontinuous layer 10.

The first discontinuous layer 10 may comprise two tubular modules, five tubular modules, preferably ten tubular modules, more preferably fifteen tubular modules and even more preferably twenty tubular modules.

Alternatively, the tubular modules comprise several pores, and the first discontinuous layer is microporous.

The average size of pores in the tubular module 11 of the first discontinuous layer 10 is not particularly limited, it is preferably smaller than or equal to 100 μm (for micrometer), preferably smaller than 50 μm, more preferably smaller than 10 μm and the most preferably comprised between 0.005 μm to 1 μm. The size of pores depends of the mixture to be separated, and the skilled in the art will know which will be suitable.

The thickness of the first discontinuous layer 10 is defined by the thickness of tubular modules 11. The thickness of the first discontinuous layer 10 may be comprised between 100 μm and 2 mm (for millimeter), preferably between 500 μm and 2 mm, more preferably between 500 μm to 1.5 mm.

The length of the first discontinuous layer 10 may be at least 50 cm, preferably at least 100 cm, more preferably at least 150 cm (for centimeter) and even more preferably 200 cm. A tubular module 11 may have itself a length between 25 mm and 150 mm.

In a particular embodiment, when having a circular cross section of the tubular electrochemical separation unit, the first discontinuous layer has inner dimensions (i.e. diameter) comprised between 1 mm and 50 mm.

In a particular embodiment, space 12 between each successive tubular module 11 of the first discontinuous layer may be comprised between 0.5 mm and 50 mm, more preferably between 1 mm and 5 mm.

The tubular electrochemical separation unit 40 may comprise a second discontinuous layer 20. The second discontinuous layer 20 comprises several successive tubular modules 21 of the second layer separated by spaces 22, so that the first discontinuous layer 10 comprises tubular modules 11 partially coated with tubular modules of the second discontinuous layer 20. Preferably, each tubular module 11 of the first discontinuous layer 10 comprises no more than 15% not coated by tubular modules 21 of the second discontinuous layer, more preferably no more than 10% and even more preferably no more than 5%. However, each tubular module 11 of the first discontinuous layer 10 is not entirely coated by the second discontinuous layer. Hence, each tubular module 11 of the first discontinuous layer 10 comprises no more than 99.9% coated by a tubular module 21 of the second discontinuous layer, more preferably no more than 99.5% and even more preferably no more than 99% coated by a tubular module 21 of the second discontinuous layer.

The second discontinuous layer 20 is compatible with the transport and migration of the ions or molecules that crosses it. Thus, the second discontinuous layer may have at least two properties: conductor for molecule or ion and electrical conductor. Advantageously, the second discontinuous layer 20 is an electrochemical membrane and more preferably an electrochemical separation membrane.

The second discontinuous layer 20 is, preferably an ion-conductive electrochemical layer, and more preferably a hydrogen or oxygen or sulfide transport electrochemical layer, and even more preferably a proton transport electrochemical layer.

It is preferred if the layer material is electrically inert and stable with temperature and chemical reaction.

In a specific embodiment where electrochemical cells of tubular electrochemical separation unit of the invention are devoted to separate gaseous mixtures, the second discontinuous layer 20 may be used at a temperature of higher than or equal to 100° C. Therefore, it is preferred that the second discontinuous layer 20 has a heat resistance higher than or equal to 100° C.

The second discontinuous layer 20 may comprise at least one component selected from: metal oxide, mixed metal oxide, La, Ba, Sr, Ca, Ce, Zr, Ti, In, Tb, Th, Y, Yb, Gd, Pr, Sc, Fe, Eu, Sm or Cr or a mixture thereof. The second discontinuous layer 20 may also include doped ions or molecules. The second discontinuous layer 20 may comprise metal mixed oxides perovskite BaZrO₃ doped Yttrium or perovskite CaCeO₃ doped Yttrium and their respective composite-ceramic oxide and nanocomposite materials such as lanthanide niobates and tungstates, yttria stabilized zirconia, carbonate-ion conductive membrane, H₂S, ZnO/conductive-ceramic nanocomposite, polymers and preferably conductive polymers such as polythiphenes, polyanilines, polypyrols, and polyacetylen.

The second discontinuous layer 20 separates the reaction at the first discontinuous layer 10 from the third discontinuous layer 30. Preferably, the second discontinuous layer 20 allows to selectively transport ion or molecule coming from the dissociation occurring at the first discontinuous layer 10. The second discontinuous layer 20 improves or participates in the dissociation and separation of species of the mixture treated by the tubular electrochemical separation unit of the invention.

The second discontinuous layer 20 includes appropriate properties for use with ion or molecule coming from the first discontinuous layer 10: mechanical work, metal working, electrical work, heat, chemical kinetics, conductivity.

In one embodiment with gases, the second discontinuous layer 20 is adapted to gas separation, in other words said second discontinuous layer 20 does not have gas resistance against gas components to be selected through separation of gaseous mixture.

Ideally, the second discontinuous layer 20 transports ions and its conductivity is at least 1.10⁻³ S/cm (for Siemens per centimeter), especially 5.10⁻³ S/cm.

Advantageously, the second discontinuous layer 20 is composed of several successive tubular modules 21. The tubular module 21 is a part of the second layer. The second discontinuous layer 20 is a recurrence of a pattern as 21-22-21-22 where 21 is a tubular module or a part of the second layer and 22 is an area or space which is not filled with material of the second layer (i.e. substance of tubular module 21). The pattern 21-22-21-22 allows to provide a discontinuous layer and more particularly the second discontinuous layer 20.

The second discontinuous layer 20 may comprise two tubular modules, five tubular modules, preferably ten tubular modules, more preferably fifteen tubular modules and even more preferably twenty tubular modules.

The thickness of the second discontinuous layer 20 is defined by the thickness of tubular modules 21. The thickness of the second discontinuous layer 20 may be comprised between 100 μm and 2 mm, preferably between 200 μm and 2 mm, more preferably between 500 μm to 1.5 mm.

Alternatively, the second discontinuous layer comprises several pores in its composition. The average size of pores in the tubular module 21 of the second discontinuous layer 20 is not particularly limited, it is preferably smaller than or equal to 100 μm, preferably smaller than 50 μm, more preferably smaller than 10 μm and the most preferably comprised between 0.005 μm to 1 μm. The size of pores depends of the mixture to be separated, and the skilled in the art will know which will be suitable. Alternatively, the pore formed in the second discontinuous layer 20 and may have a diameter of 1 nm (for nanometer) to 100 nm or 5 nm to 80 nm.

The length of the second discontinuous layer 20 may be at least 50 cm, preferably at least 100 cm, more preferably at least 150 cm and even more preferably at least 200 cm. A tubular module 21 of the second discontinuous layer 20 may have itself a length between 25 mm and 150 mm.

In a particular embodiment, space 22 between each successive tubular module 21 of the second discontinuous layer 20 may be comprised between 0.5 mm and 50 mm, more preferably between 1 mm and 5 mm.

The tubular electrochemical separation unit 40 may comprise a third discontinuous layer 30. The third discontinuous layer 30 comprises several successive tubular modules 31 of the third layer separated by spaces 32, so that tubular modules 21 of the second discontinuous layer 20 are partially coated with tubular modules 31 of the third discontinuous layer 30. Preferably, each tubular module 21 of the second discontinuous layer 20 comprises no more than 15% not coated by tubular modules 31 of the third discontinuous layer, more preferably no more than 10% and even more preferably no more than 5%. However, each tubular module 21 of the second discontinuous layer 20 is not entirely coated by the third discontinuous layer. Hence, each tubular module 21 of the second discontinuous layer 20 comprises no more than 99.9% coated by a tubular module 31 of the third discontinuous layer, more preferably no more than 99.5% and even more preferably no more than 99% coated by the third discontinuous layer. More preferably a tubular module 31 of the third discontinuous layer 30 of an electrochemical cell 50 is in contact with a tubular module 11 of the first discontinuous layer 10 of an adjacent electrochemical cell 51. In addition, in a preferred embodiment, a tubular module 31 of the third discontinuous layer 30 of an electrochemical cell 50 is also in contact with a tubular module 21 of the second discontinuous layer 20 of an adjacent electrochemical cell 51.

The third discontinuous layer 30 is, preferably, an external electrode. Indeed, the electrochemical driving force for the transport across the membrane of the tubular electrochemical separation unit, is the result of external voltage being applied through said membrane, i.e. including the first discontinuous layer 10 and the third discontinuous layer 30. Thus, the tubular electrochemical separation unit is provided with electrodes in order to separate, dissociate, the mixture introduced within said separation unit.

As example, the third discontinuous layer 30 may be a cathode. A cathode may be a negative electrode, but the invention is not limited to this configuration and the external electrode could also be a positive electrode such as an anode. The configuration depends on the species to be separated and providing that the counterpart electrode (i.e. first layer) is defined accordingly to allow electrochemical separation. There is no particular limitation on the material to be used in the electrochemical separation unit of the invention providing that is electrically active for instance in an embodiment, an electrode may be manufactured by binding an electrode active material to a current generator by a typical method known in the art. For example, active material of the cathode may include as a non-limiting example, a general cathode active material usable in a cathode of a conventional electrochemical cell, in particular, lithium manganese oxide, lithium cobalt oxide, lithium nickel oxide, lithium iron oxide, or lithium composite oxides thereof.

Thus, the third discontinuous layer 30 allows to an electrical current to pass through the electrochemical separation unit.

The third discontinuous layer 30 may comprise ceramics, conductive materials, may be selected from, but not limited to: Ni, Fe, Pt, Pd, Ba, Sr, Y, Ca, Yb, Pr, Eu, Pr, In, Sc, Ce, Acc, O, Cu, Li, Al, Au, Ag, Acetylene, Acetylene black, carbon, carbon black or mixture of thereof, and salts of thereof. Advantageously, the composition of the third discontinuous layer 30 is adapted to the mixture to be separated, in other words, the choice of metal depends on the design, the desired activity and the compatibility with the tubular electrochemical unit.

Additionally, the third discontinuous layer 30 may comprise some optional additives such as pore formers, emulsifiers, binders, rheology modifiers, precursors of metal oxide, conductors. Optional additives allow to confer specific properties to the third discontinuous layer 30 according to the mixture to be separated. Optional additives may be comprised between 0% and 10% of components as a whole of the third discontinuous layer 30.

The third discontinuous layer 30 is preferably electrically conductive, allowing gas diffusion, and molecule/ion can pass through.

The third discontinuous layer 30 is made with known technologies in the art including but not be limited to: extrusion, co-extrusion, slip casting doctor-blade coating, spay-coating, physical vapor deposition, plasma enhanced chemical deposition, laminated. These deposition methods can be followed by sintering or co-firing improvement steps to modify material properties. Alternatively, the third discontinuous layer 30 is microporous.

Once in the tubular electrochemical separation unit, gas, liquid, solid or plasma are separated, then only one molecule or ion crosses the second discontinuous layer 20 and finally comes in the third discontinuous layer 30 in order to be removed. In a preferred embodiment, gases flow inside of the first discontinuous layer 10, when they are injected in the tubular electrochemical separation unit, and are separated, then only one molecule or ion crosses the second discontinuous layer 20 and finally comes in the third discontinuous layer 30 in order to be removed. Either the species arriving at the third layer or the species remaining in the tube can be collected.

The third discontinuous layer 30 may present an ability to support/promote redox reactions of chemical species to recombine ionic species. The third discontinuous layer 30 enables redox reaction of the transported molecule, and, preferably, allows to associate molecules or ions leaving the second discontinuous layer 20.

In addition, the third discontinuous layer 30 may present a pressure resistance, a temperature resistance and area specific resistance similar to the first discontinuous layer 10.

The third discontinuous layer 30 is adapted to different mixtures transport, and to different technologies developing pressure as nano-filtration or reverse osmosis. As well, the third discontinuous layer 30 enables heat management, and the third discontinuous layer 30 is stable even in chemically harsh conditions at high temperatures.

Advantageously, the third discontinuous layer 30 is composed of several successive tubular modules 31. Tubular module 31 is a part of the third layer. The third discontinuous layer 30 is equally a recurrence of a pattern 31-32-31-32 as the first and second discontinuous layer switching between tubular module 31 of the third layer and empty space 32.

The third discontinuous layer 30 may comprise two tubular modules, five tubular modules, preferably ten tubular modules, more preferably fifteen tubular modules and even more preferably twenty tubular modules. Alternatively, the tubular modules comprise several pores, and the third discontinuous layer is microporous. The same with the average size pores in tubular modules of first discontinuous layer 10 should be applicable to the third discontinuous layer 30. The average size of pores in the tubular module 31 of the third discontinuous layer 30 is not particularly limited, it is preferably smaller than or equal to 100 μm, preferably smaller than 50 μm, more preferably smaller than 10 μm and the most preferably comprised between 0.005 μm to 1 μm. The size of pores depends of the mixture to be separated, and the skilled in the art will know which will be suitable.

The thickness of the third discontinuous layer 30 may be similar of the first discontinuous layer 10 or different. However, the thickness of the third discontinuous layer is defined by the thickness of tubular modules 31. The thickness of the third discontinuous layer 30 may be comprised between 100 μm and 2 mm, preferably between 200 μm and 2 mm, more preferably between 500 μm to 2 mm and even more preferably between 500 μm and 1.5 mm.

It is also the case with the length of the third discontinuous layer 30, which may be identical to the length of first discontinuous layer 10. The same should be applicable with the length of tubular module between the first and the third layer. The length of the third discontinuous layer 30 may be at least 50 cm, preferably at least 100 cm, more preferably at least 150 cm and even more preferably at least 200 cm. A tubular module 31 may have itself a length between 25 mm and 150 mm.

In a particular embodiment, space 32 between each successive tubular module 31 of the third discontinuous layer may be comprised between 0.5 mm and 50 mm, more preferably between 1 mm and 5 mm.

According to an embodiment to present invention, it is preferred that the distance from the second discontinuous layer 20 to the first and the third discontinuous layers is as short as possible, preferable no more than 15 mm and more preferable less than 5 mm.

Advantageously, the tubular electrochemical separation unit 40 comprises several electrochemical cells 50,51 arranged electrically in series and wherein a tubular module 31 of the third discontinuous layer 30 of an electrochemical cell 50 is in contact with a tubular module 11 of the first discontinuous layer of an adjacent electrochemical cell 51. Preferably, the contact between a tubular module 31 of the third discontinuous layer 30 of an electrochemical cell 50 and a tubular module 11 of the first discontinuous layer 10 of an adjacent electrochemical cell 51 is a direct contact. In other word, at this location, it would be better if no intermediate layer or materials be present between the first discontinuous layer 10 and the third discontinuous layer 30.

Advantageously, the direct contact is made on only one the part of each tubular module 11 of the first discontinuous layer and only one part of each tubular module 31 of the third discontinuous layer 30. Preferably, the only one part of each tubular module 11 of the first discontinuous layer corresponds to the part of each tubular module 11 of the first discontinuous layer 10 not coated with a tubular module of the second discontinuous layer. More preferably the direct contact is made on each tubular module 11 of the first discontinuous layer. Only 15% of each tubular module 11 of the first discontinuous layer, more preferably 10% of each tubular module 11 of the first discontinuous layer 10 and even more preferably, only 5% of each tubular module 11 of the first discontinuous layer is in direct contact with tubular modules 31 of the third discontinuous layer 30.

Advantageously, the direct contact is an electrical contact and more preferably a direct electrical contact. In a particularly advantageous way, this allows an electrical continuity between the first 10 and the third 30 discontinuous layers of two adjacent electrochemical cells and the electrical connection in series of adjacent electrochemical cells. With this arrangement, no more welding is necessary, no more electrical insulator and conductive materials to obtain an electrical connection in series is necessary. This specific arrangement according to the invention allows to decrease productive cost but also to decrease risks of failure.

Advantageously, the direct contact between a tubular module 31 of the third discontinuous layer 30 of an electrochemical cell 50 and a tubular module 11 of the first discontinuous layer 10 of an adjacent electrochemical cell 51 allows to improve the length of the tubular electrochemical separation unit 40. Furthermore, this arrangement allows several electrochemical separation units to be in the same enclosure while taking less place.

More advantageous, the direct contact between a tubular module 31 of the third discontinuous layer 30 of the electrochemical cell 50 and a tubular module 11 of the first discontinuous layer 10 of an adjacent electrochemical cell 51 allows a serial power connection and a serial electrical connection. The connection allows a serial power and electrical connection all along the tubular electrochemical separation unit 40.

Thanks to the direct contact between a tubular module 31 of the third discontinuous layer 30 of an electrochemical cell 50 and a tubular module 11 of the first discontinuous layer 10 of an adjacent electrochemical cell 51, the reliability is increased.

In addition, this specific arrangement allows to decrease the cost of the materials used and to decrease the number of production step and cost production.

Thanks to the present invention, it is possible to produce several electrochemical cells with electrical contact in series within the same tube.

Another advantage of the invention is that the tubular electrochemical separation unit 40 may be used in all fields of separation and preferably, electrochemical separation. For example, the invention will be use with fuel cell.

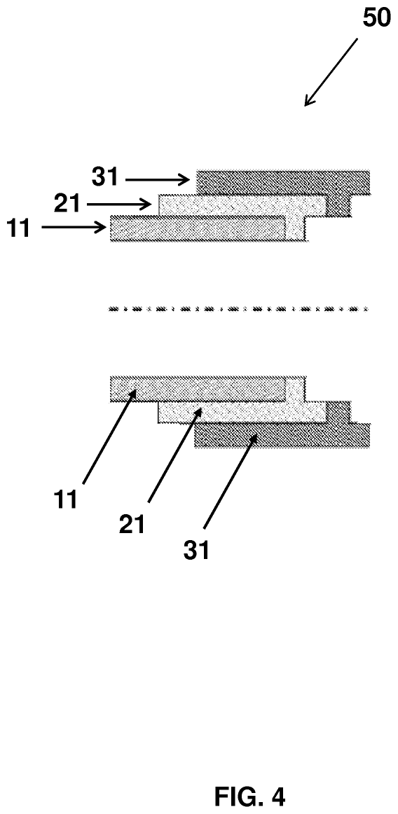

In one embodiment, the tubular electrochemical separation unit 40 comprises several tubular electrochemical cells. One tubular electrochemical cell 50 as illustrated on the FIG. 4 may comprise at least three layers, preferably formed from the first discontinuous layer 10, the second discontinuous layer 20 and the third discontinuous layer 30 as disclosed above, and more preferably, one electrochemical cell 50,51 comprises one tubular module 11 of the first discontinuous layer 10, one tubular module 21 of the second discontinuous layer 20 and one tubular module 31 of the third discontinuous layer 30.

Each discontinuous layer may comprise several tubular modules 11, 21, 31.

In an embodiment, the contact between the tubular module 31 of the third discontinuous layer 30 of an electrochemical cell 50 and the tubular module 11 of the first discontinuous layer 10 of an adjacent electrochemical cell 51 is a direct contact.

Thanks to the direct contact between a tubular module 31 of the third discontinuous layer 30 of an electrochemical cell 50 and a tubular module 11 of the first discontinuous layer 10 of an adjacent electrochemical cell 51, the reliability is increased.

Preferably, a tubular module 31 of the third discontinuous layer 30 of the electrochemical cell 50 is, also, in contact with a tubular module 21 of the second discontinuous layer 20 of the adjacent electrochemical cell 51. This is to provide a continuity between the third discontinuous layer 30 and second discontinuous layer 20 for improving the transport and separation of the mixture to be separated.

Thanks to the special arrangement of the tubular modules of discontinuous layers, no more electrical insulators and conductive materials are needed, and the productive costs are decreased. Hence, the length of the tubular electrochemical separation unit 40 can be greater than the existing electrochemical separation units with a good reliability and safety.

According to another embodiment of the invention, the tubular electrochemical separation unit 40 may have an internal diameter comprised between 5 mm and 50 mm, preferably between 5 mm and 25 mm and more preferably between 5 mm and 10 mm. A reduced internal diameter allows a better circulation of gases. An external diameter of the tubular electrochemical separation unit 40 depends on the thickness on the three layers and may be at least 5.6 mm.

Advantageously, the tubular electrochemical separation unit 40 may comprise at least two electrochemical cells, preferably five, more preferably ten, and even more preferably more than ten.

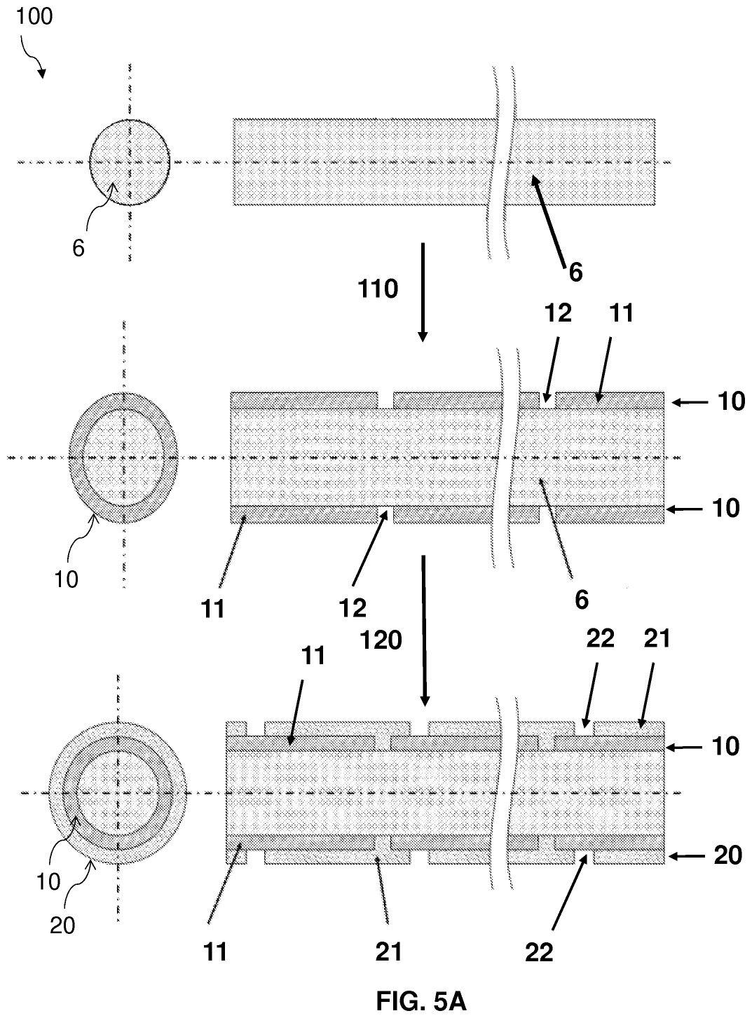

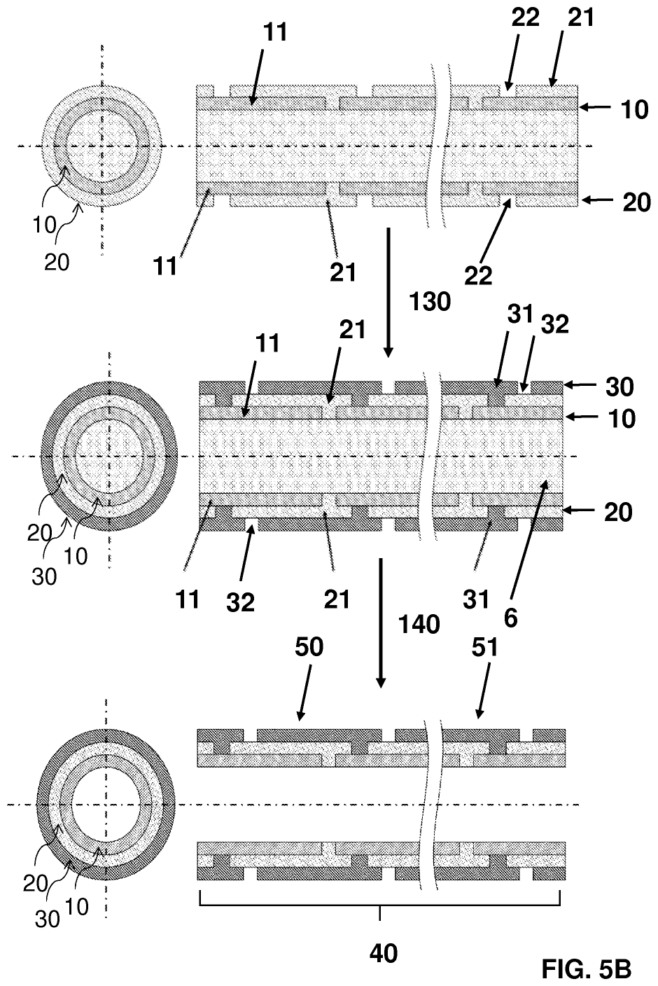

According to another aspect of the invention, it is provided a method 100 for producing a tubular electrochemical separation unit 40, said tubular electrochemical separation unit comprising a plurality of electrochemical cells 50, 51 arranged electrically in series, each electrochemical cell comprising at least three layers as illustrated in FIGS. 5A and 5B.

The method comprises a deposition step 110 of a first layer, as illustrated on FIG. 5A. The deposition step 110 is achieved to form a first discontinuous layer 10. The first discontinuous layer 10 comprises several successive tubular modules 11 separated by spaces 12.

The first discontinuous layer 10 may be deposited on a support 6. Alternatively, the tubular unit 11 of the invention is self-supported.

The support 6 may be of any shape or geometry, as square, rectangular, tubular, cylindrical, planar, and curvilinear. Preferentially, the support is cylindrical or tubular.

The support 6 may be inert, porous, chemically compatible with the first discontinuous layers 10, mechanically compatible with the first discontinuous layer 10, sacrificial or even a mold.

The support 6 may include any porous metal material that is suitable for use as a support for the first discontinuous layer 10. The porous metal material can be selected from any of the material known in the art. Advantageously, the support 6 may comprise metal oxide, stainless steel, carbon steel, ceramic, alumina, porous alumina, cellulose, foam, polymer, and any combination thereof. The support 6 may also include additional metal as Ni, Mo, Mn, Si, SiC and any combination thereof.

Advantageously, the support resists to the thermal expansion. A support with mold is easier for use with the invention. Preferably the invention uses a support with mold and advantageously the mold may be a structured mold in its internal surface for a better circulation of gases and diffusion. Preferably, the circulation of gases according to the invention follows a laminar flow.

The thickness, porosity, and pore size distribution of the pores of the support 6 are properties selected in order to provide a separation membrane that has the desired properties required in the process of manufacturing the separation membrane. The thickness of the support 6 for typical application can be comprised between 0.001 mm and 25 mm, preferably between 1 mm and 15 mm, and more preferably, between 2 mm and 10 mm. Preferably, the thickness of the support 6 may correspond to the internal diameter. The internal diameter may be comprised between 5 mm and 50 mm, preferably between 5 mm and 25 mm and more preferably between 5 mm and 10 mm.

The porosity of the porous metal support can be in the range of from 0.01 to 1.0. (i.e. non-solid and solid) of the porous metal support material.

The support 6 may have an external surface that permits the application of the first discontinuous layer 10. Alternatively, the support 6 may be non-conductive. In other way, the support may promote the contact surface with gases in such a way that in a particular embodiment of the invention, the first discontinuous layer 10 and the support 6 form one single entity.

Alternatively, the support 6 may be a sacrificial support, a temporary support.

The method according to the invention may comprise a step of treatment of the support. Treatments may provide separation properties, permeability and inhibit dewatering. Preferentially, the surface tension of support 6 may be compatible with the first discontinuous layer 10, thereby decreasing the interfacial resistance. The surface of the support 6 may be preliminary, neutralized or pseudo-neutralized.

After the deposit step 110 of the first discontinuous layer 10 (on a support or self-supporting), the method 100 according to the invention may comprise a step of intermediate treatments of the first discontinuous layer 10. These treatments include chemical treatments or physical treatments.

These treatments allow to improve properties of the first discontinuous layer 10 or to improve the properties in order to facilitate the other steps of the method.

The method 100 according to the invention may comprise a deposition step 120 of a second layer as illustrated on FIG. 5A. The deposition step 120 is achieved to form a second discontinuous layer 20. The second discontinuous layer 20 comprises several successive tubular modules 21 separated by spaces 22, so that tubular modules 11 of the first discontinuous layer 10 are partially coated with tubular modules 21 of the second discontinuous layer 20. Preferably, the deposition step 120 of the second discontinuous layer is achieved so that each tubular module 11 of the first discontinuous layer 10 comprises no more than 15% not coated by the second discontinuous layer, preferably no more than 10%, more preferably no more than 5% and even more preferably no more 1%. However, each tubular module 11 of the first discontinuous layer 10 is not entirely coated by the second discontinuous layer. Hence, each tubular module 11 of the first discontinuous layer 10 comprises no more than 99.9% coated by a tubular module 21 of the second discontinuous layer, more preferably no more than 99.5% and even more preferably no more than 99% coated by a tubular module 21 of the second discontinuous layer.

According to an embodiment, the deposition step 120 of the second discontinuous layer 20 is carried out on the surface of the first discontinuous layer 10.

Advantageously, the deposition step 120 of the second discontinuous layer 20 is achieved so that two successive tubular modules 11 of the first discontinuous layer 10 are partially coated with a tubular module 21 of the second discontinuous layer 20.

Advantageously, the deposition step 120 of the second discontinuous layer 20 is achieved so that a space 12 between two successive tubular modules 11 of the first discontinuous layer 10 is filled with a tubular module 21 of the second discontinuous layer 20.

This is to provide a continuity between the first discontinuous layer 10 and second discontinuous layer 20 for improving the transport and separation of the mixture to be separated.

Preferably, the deposition step 120 of the second layer, is achieved so that the first discontinuous layer 10 is in direct contact with the second discontinuous layer 20. In other word, it would be better if no intermediate layer is present between the first and the second discontinuous layer. Nevertheless, an intermediate layer could be present according to the mixture to be separated, in order to enhance the performance of the first and/or the second discontinuous layer.

The method according to the invention may comprise a deposition step 130 of a third layer, as illustrated on the FIG. 5B. The deposition step 130 is achieved to form a third discontinuous layer 30. The third discontinuous layer 30 comprises several successive tubular modules 31 separated by spaces 32, so that tubular modules 21 of the second discontinuous layer 20 are partially coated with tubular modules 31 of the third discontinuous layer 30. Said deposition steps resulting in the formation of electrochemical cell arranged electrically in series wherein a tubular module 31 of the third discontinuous layer 30 of an electrochemical cell 50 is in contact with a tubular module 11 of the first discontinuous layer 10 of an adjacent electrochemical cell 51.

Advantageously, said deposition steps resulting in the formation of electrochemical cell arranged electrically in series wherein a tubular module 31 of the third discontinuous layer 30 of the said electrochemical cell 50 is also in contact with a tubular module 21 of the second discontinuous layer 20 of the said adjacent electrochemical cell 51.

According to an embodiment of the present disclosure, the deposition step 130 of the third discontinuous layer 30 is carried out on the surface of the first discontinuous layer 10 and the second discontinuous layer 20. According to the invention, the word “surface” means the outside part and more preferably, the outside and upper side of the first and second discontinuous layer 10, 20 when the invention relates the third discontinuous layer 30. In addition, it is preferred that the second discontinuous layer 20 is arranged between the first and the third discontinuous layers 10, 30.

Advantageously, the deposition step 130 is achieved so that two successive tubular modules 21 of the second discontinuous layer 20 are partially coated with a tubular module 31 of the third discontinuous layer 30. Preferably, each tubular module 21 of the second discontinuous layer 20 comprises no more than 15% not coated by the third discontinuous layer, preferably no more than 10% more preferably no more than 5% and even no more than 1%. However, each tubular module 21 of the second discontinuous layer 20 is not entirely coated by the third discontinuous layer. Hence, each tubular module 21 of the second discontinuous layer 20 comprises no more than 99.9% coated by a tubular module 31 of the third discontinuous layer, more preferably no more than 99.5% and even more preferably no more than 99% coated by the third discontinuous layer.

Advantageously, the deposition step 130 is achieved so that the space 22 between two successive tubular modules 21 of the second discontinuous layer 20 is filled with a tubular module 31 of the third discontinuous layer 30.

This is to provide a continuity between the second discontinuous layer 20 and third discontinuous layer 30 for improving the transport and separation of the mixture to be separated.

In a preferred embodiment according to the invention, the deposition steps are achieved so that the second discontinuous layer 20 is in direct contact with the third discontinuous layer 30. More preferably, the first discontinuous layer 10 is in direct contact with the third discontinuous layer 30. Indeed, at the contact between the first and the third discontinuous layers 10, 30, no intermediate is present.

More precisely, the contact between the first 10 and the third 30 discontinuous layers comprises a contact between a tubular module 31 of the third discontinuous layer 30 of an electrochemical cell 50 and a tubular module 11 of the first discontinuous layer 10 of an adjacent electrochemical cell 51. More preferably the direct contact is made on each tubular module 11 of the first discontinuous layer and only 15% of each tubular module 11 of the first discontinuous layer, preferably 10% of each tubular module 11 of the first discontinuous layer 10 more preferably, only 5% of each tubular module 11 of the first discontinuous layer and even more preferably only 1% of each tubular module 11 of the first discontinuous layer is in direct contact with tubular modules 31 of the third discontinuous layer 30.

Thus, the contact between the tubular module 31 of the third discontinuous layer 30 of the electrochemical cell 50 and the tubular module 11 of the first discontinuous layer 10 of the adjacent electrochemical cell 51 is a direct contact. Advantageously, the direct contact is an electrical contact and more preferably a direct electrical contact. In a particularly advantageous way, this allows an electrical continuity between the first discontinuous layer 10 of an electrochemical cell 50 and the third discontinuous layers 30 of an adjacent electrochemical cell 51.

In addition, this specific arrangement allows to decrease the number of steps in a production process, and to decrease the cost of the materials used.

Thanks to the present invention, it is possible to produce several tubular electrochemical separation units with electrical contact in series.

According to another embodiment of the invention, the deposition step 130 is achieved so that a tubular module 31 of the third discontinuous layer 30 of an electrochemical cell 50 is, also, in contact with a tubular module 21 of the second discontinuous layer 20 of a membrane of an adjacent electrochemical cell 51. This is to provide a continuity between the second discontinuous layer 20 and the third discontinuous layer 30 for improving the transport and separation of the mixture to be separated.

As already described, the method according to the invention may comprise a deposition step 110 of a first discontinuous layer 10, a deposition step 120 of a second discontinuous layer 20 and a deposition step 130 of a third discontinuous layer 30.

The invention consists in depositing the layers in an offset manner so as to create a series arrangement of the tubular electrochemical separation unit 40 and allow the electric current to pass from the internal electrode of one electrochemical cell to the external electrode of the adjacent electrochemical cell.

The deposition process may be selected from, but not limited to extrusion, co-extrusion, slip casting, injection molding, tape casting, spray coating, spin coating, bar coating, die coating, blade coating, air-knife coating, roll coating, gravure coating, dip coating, ink jet printing, screen printing chemical vapor deposition, physical vapor deposition, Langmuir-Blodgett, atomic layer deposition, plasma-enhanced chemical deposition, evaporation deposition, sputtering, molecular beam epitaxy, pulsed laser deposition, electrohydrodynamic, electroless plating, thermal deposition, electroplating, spray deposition, sputter coating, e-beam evaporation, ion beam evaporation, spray pyrolysis.

The deposits of layers may be operated by successive steps in time and/or separate areas.

According to an embodiment, the depositions steps are sequenced in areas.

In this context, a tape may be used to hide a part of the lower layer. The tape is subsequently removed in order to form a discontinuous layer. The hidden part by the tape form the space between two successive tubular modules, tubular module being formed by the absence of the tape.

In the embodiment with support, the deposition of the first discontinuous layer 10 is made with a tape positioned on the support 6.

In the embodiment without support, or self-supporting, the tape is positioned on a cylinder which is the cylinder placed under an injection zone allowing the formation of a discontinuous layer.

When the first discontinuous layer 10 is formed, the tape is positioned on the first discontinuous layer 10 allowing to form the second discontinuous layer 20.

Alternatively, the tape may be replaced with mask, duct, or any other means allowing to hide a lower layer.

Alternatively, the tape may be replace with other method selected from, but not limited to laser-ablation, etching, laser etching, gas chemistry, chemical etching, plasma etching, wet etching, or physical etching, air, CO₂, water, ion beam, irradiation.

According to another embodiment of the invention, the deposition steps are time-sequenced.

This sequenced deposition can be performed in way which consists to stop the deposition of the layer during the advance of the cylinder under the injection zone to allow the continuous formation of deposited tubular module of layer and empty space.

Advantageously, the invention comprises neither electrical insulators nor conductive materials deposited between two adjacent tubular electrochemical cells.

The method may comprise an intermediate step between each deposit, said intermediate step comprising chemical or physical treatments. The intermediate step may take place before the deposit of the first discontinuous layer 10 (treatment of the support), before the deposit of the second discontinuous layer 20 or before the deposit of the third discontinuous layer 30. For example, these deposition steps may be followed by sintering or co-firing.

The method 100 according to the invention may comprise a step 140 of removing the support 6 as shown in FIG. 5B.

In the embodiment with the support 6, when all layers are deposited, the support may be removed.

A removal technique may be selected from burning, prescribed burning, controlled burning, and pyrolysis or easier in the embodiment with a mold by removing the mold. Preferably, the support is removed but in other embodiment the support may be kept, in this way, the support is porous and not electrically conductive.

According to another aspect of the present invention, it is provided a use of a tubular electrochemical separation unit 40 for electrochemical separation of molecular species. Molecular species may correspond to different states as gaseous, liquid, solid.

The tubular electrochemical separation unit 40 as disclosed may be used as an electrochemical device. Non-limiting examples of electrochemical devices in which the tubular electrochemical separation unit 40 according to the present invention may be employed may include any device which implying an electrochemical reaction. Specifically, for example, all types of primary batteries, secondary batteries, fuel cells, solar cells, or capacitors such as super-capacitors, separation, filtration, reforming, and treatment devices.

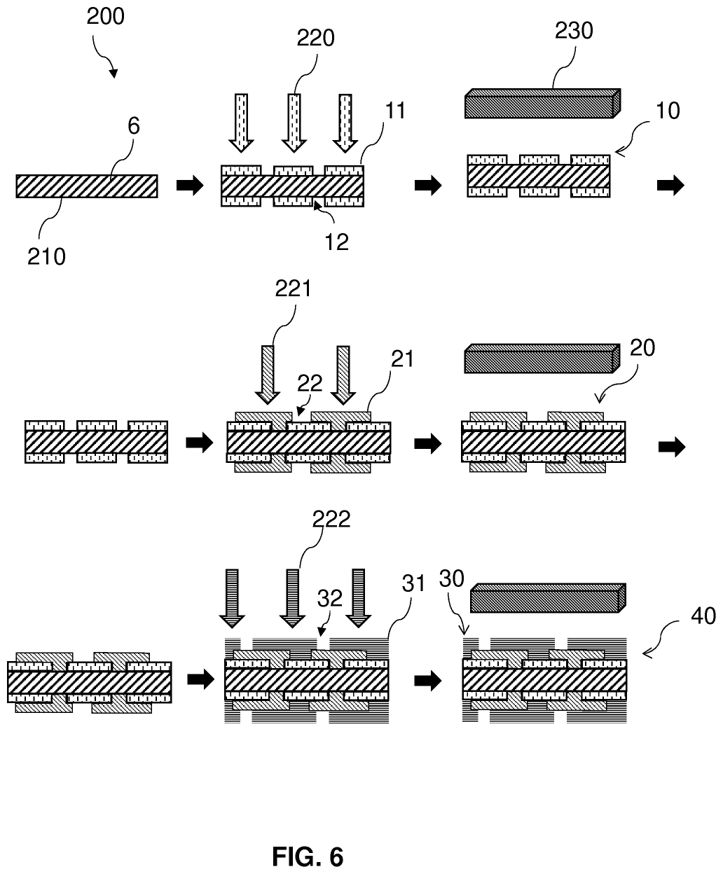

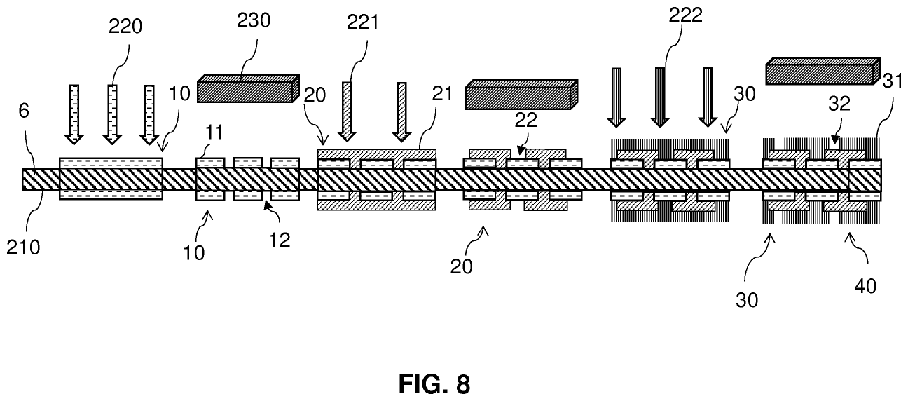

According to another embodiment, the invention concerns a system 200 for producing a tubular electrochemical separation unit 40 as shown in FIG. 6 or FIG. 8.

Advantageously, a system according to the invention allows the continuous manufacture of a tubular electrochemical separation unit 40 in line and without frequent handling.

The system may comprise means of transport 210 configured to forward at least one layer.

Advantageously, the means of transport is configured to forward the support 6 and/or the first layer and/or the second layer and/or the third layer. Preferably, the means of transport is configured to forward the support 6 and/or the first discontinuous layer 10 and/or the second discontinuous layer 20 and/or the third discontinuous layer 30.

The means of transport may correspond to any routing means, such as roller, cylinder, arm, tunnel, wheel, rolling and rotating. Preferably the means of transport is rotating allowing to form a tubular structure. Alternatively, the means of transport may correspond to rotary impregnation device.

The transit time is short and little exposed to light or air.

Advantageously, the means of transport are configured according to a predetermined speed may comprise various factors as time, distance, length of layers, thickness of layers.

Preferably the means of transport is in motion and continuous (as illustrated by the black arrows in the FIG. 6). However, the means of transport may be configured to alternate motion and stop.

The system according to the invention may comprise means of deposition 220. Preferably, the system comprises several means of deposition for each layer, but the system is not limited to this embodiment and may comprise only one means of deposition. According to this way, the transit time will be longer. It will be necessary to wash the means of deposition between each deposition of different layer.

According to the embodiment with the rotary impregnation device, the means of deposition may correspond to tanks comprising the material of layers. The first tank comprises the material of the first layer, the second tank comprises the material of the second layer and the third tank comprises the material of the third layer.

According to a preferred embodiment, the system comprises one or several means of deposition 220 of the first discontinuous layer and in particular for several tubular modules 11 of the first discontinuous layer separated by space 12. Preferably the means of deposition 220 are configured to implement the step 110 of the first discontinuous layer as explain below.

Equally, the system may comprise means of deposition 221 of the second discontinuous layer and in particular for several tubular modules 21 of the second discontinuous layer separated by spaces 22. Preferably the means of deposition 221 are configured to implement the step 120 of the second discontinuous layer as explain below.

This is also the case with means of deposition 222 of the third discontinuous layer and in particular for several tubular modules 31 of the third discontinuous layer separated by spaces 32. Preferably the means of deposition 222 are configured to implement the step 130 of the third discontinuous layer as explain below. The means of deposition may be separated in space or in area equally as explain below.

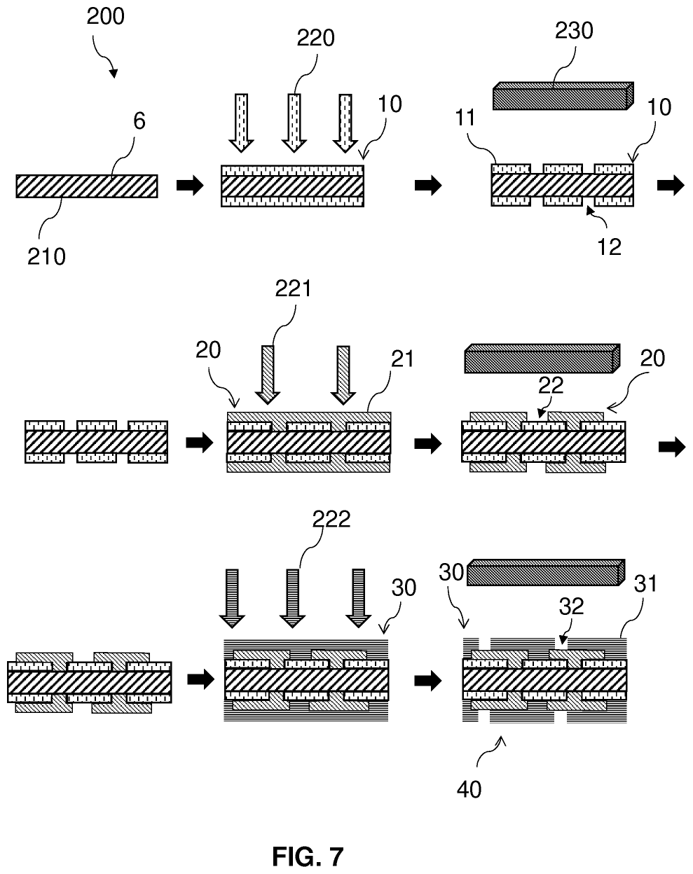

The means of deposition may be configured to perform a tubular discontinuous deposit, alternating the deposition of a module and the stop of the deposit according to a predetermined time (corresponding to the space between each module). Alternatively, the means of deposition may comprise a mask configured to create the space between two successive tubular modules of discontinuous layers, as explain below. According to another embodiment, the means of deposition may be configured to achieve a tubular continuous deposition of each layer (as illustrated in FIG. 7).

The means of deposition may be previously programmed to make a tubular continuous or a tubular discontinuous deposit over a predefined period.

The means of deposition may correspond to extrusion, co-extrusion, slip casting, injection molding, tape casting, spray coating, spin coating, bar coating, die coating, blade coating, air-knife coating, roll coating, gravure coating, dip coating, ink jet printing, screen printing chemical vapor deposition, physical vapor deposition, Langmuir-Blodgett, atomic layer deposition, /plasma-enhanced chemical deposition, evaporation deposition, sputtering, molecular beam epitaxy, pulsed laser deposition, electrohydrodynamic, electroless plating, thermal deposition, electroplating, spray deposition, sputter coating, e-beam evaporation, ion beam evaporation, spray pyrolysis.

Preferably, the means of deposition are above the means of transport. The means of transport is configured to stop under or between the means of deposition for each layer according to a predetermined time. According to the embodiment with the rotary impregnation device, the means of deposition are below the means of transport (i.e. the rotary impregnation device). The rotary impregnation device is configured to rotate in each tank (i.e.: the means of deposition) until a predetermined thickness for each layer.

The system according to the invention may also comprise one or several means for heating 230.

The means for heating are configured to heat each layer according to a predetermined and controlled time-temperature. This depends on thickness of layer, length of layer and the required mechanical, chemical and physical properties. Preferably the means for heating are configured to heat each discontinuous layer and in particular module between each deposition of discontinuous layer according to a predetermined and controlled time-temperature. Preferably the means of transport are configured to stop under the means for heating for each layer according to a predetermined time. The temperature may be comprised between 600° C. and 1800° C., preferably between 1500° C. and 1650° C.

The temperature of means for heating may change between each deposition of layer.

The means for heating may be oven, furnace, kiln, dryer, heat chamber, proofer. Preferably, the means for heating is oven.

According to the embodiment (illustrated on the FIG. 7) wherein the means of deposition may be configured to achieve a continuous deposition of each layer, the means for heating may be couple with means of removal (not illustrated). The means of removal are configured to remove a part of the continuous layer to form the discontinuous layer and more particularly, to form the spaces 12,22,32 of each layer.

In another way, the means of removal are separate from the means for heating. In this case, preferably, means of removal are arranged after the means for heating.

Means of removal may correspond to etching, and preferably chemical etching, or any other means known by the one skilled in the art configured to remove material of layer.

According to an embodiment, the system 200 may comprise means of tubular electrochemical separation unit recovery (not illustrated). Such a means of tubular electrochemical separation unit recovery may be any means known to the one skilled in the art.

Such a means of tubular electrochemical separation unit recovery allows to recover the tubular electrochemical separation unit 40 produced.

Preferably the tubular electrochemical separation unit recovery is at the end of the means of transport 210.

According to an embodiment of the present invention, the system 200 is configured to implement the method 100 for producing tubular electrochemical separation unit 40.

1. A Method for producing a tubular electrochemical separation unit, said tubular electrochemical separation unit comprising a plurality of electrochemical cells arranged electrically in series, said tubular electrochemical separation unit comprising at least three layers, said method comprising:
depositing a first discontinuous layer comprising several successive tubular modules separated by spaces,
depositing a second discontinuous layer comprising several successive tubular modules separated by spaces, so that tubular modules of the first discontinuous layer are partially coated with tubular modules of the second discontinuous layer,
depositing a third discontinuous layer comprising several successive tubular modules separated by spaces, so that tubular modules of the second discontinuous layer are partially coated with tubular modules of the third discontinuous layer,
Said deposition steps resulting in the formation of electrochemical cells arranged electrically in series wherein a tubular module of the third discontinuous layer of a first said electrochemical cell is in contact with a tubular module of the first discontinuous layer of an adjacent second said electrochemical cell,
And wherein a tubular module of the third discontinuous layer of the said first electrochemical cell is also in contact with a tubular module of the second discontinuous layer of said adjacent second electrochemical cell.

2. The Method for producing a tubular electrochemical separation unit according to claim 1, wherein the deposition of the second layer is achieved so that two successive tubular modules of the first discontinuous layer are partially coated with a tubular module of the second discontinuous layer.

3. The Method for producing a tubular electrochemical separation unit according to claim 1, wherein the deposition of the third layer is achieved so that two successive tubular modules of the second discontinuous layer are partially coated with a tubular module of the third discontinuous layer.

4. The Method for producing a tubular electrochemical separation unit according to claim 1, wherein the deposition of the second layer is achieved so that a space between two successive tubular modules of the first discontinuous layer is filled with a tubular module of the second discontinuous layer.

5. The Method for producing a tubular electrochemical separation unit according to claim 1, wherein the deposition of the third layer is achieved so that a space between two successive tubular modules of the second discontinuous layer is filled with a tubular module of the third discontinuous layer.

6. The Method for producing a tubular electrochemical separation unit according to claim 1, wherein deposition of said first, second and third layers is operated by successive steps in time and/or separate areas.

7. The Method for producing a tubular electrochemical separation unit according to claim 1, wherein the deposition of said first, second and third layers is selected from extrusion, co-extrusion, slip casting, injection molding, tape casting, spray coating, chemical vapor deposition, physical vapor deposition, doctor blade, atomic layer deposition, plasma-enhanced chemical vapor deposition, evaporation deposition, sputtering, molecular beam epitaxy, pulsed laser deposition, electrohydrodynamic spin coating, bar coating, die coating, blade coating, air-knife coating, roll coating, gravure coating, dip coating, ink jet printing, screen printing, Langmuir-Blodgett, plasma-enhanced, electroless plating, thermal deposition, electroplating, spray deposition, sputter coating, e-beam evaporation, ion beam evaporation, spray pyrolysis.

8. A Tubular electrochemical separation unit comprising a plurality of electrochemical cells arranged electrically in series, wherein said tubular electrochemical separation unit comprising at least three layers:
a first discontinuous layer, said first discontinuous layer comprising several successive tubular modules separated by spaces,
a second discontinuous layer, said second discontinuous layer comprising several successive tubular modules separated by spaces, arranged so that tubular modules of the first discontinuous layer are partially coated with tubular modules of the second discontinuous layer,
a third discontinuous layer, said third discontinuous layer comprising several successive tubular modules separated by spaces arranged so that the second discontinuous layer comprises tubular modules partially coated with tubular modules of the third discontinuous layer,
and wherein:
a tubular module of the third discontinuous layer of a first one of said plurality of electrochemical cells is in contact with a tubular module of the first discontinuous layer of an adjacent second one of said plurality of electrochemical cells, and
a tubular module of the third discontinuous layer of said first electrochemical cell is also in contact with a tubular module of the second discontinuous layer of the said second adjacent electrochemical cell.

9. The Tubular electrochemical separation unit according to claim 8, wherein:
said electrochemical cells within said tubular electrochemical separation unit are not separated by electrical insulators and/or conductive materials, and/or
said electrochemical cells within said tubular electrochemical separation unit are not assembled by welding.

10. The Tubular electrochemical separation unit according to claim 8, wherein the contact between a tubular module of the third discontinuous layer of said first electrochemical cell and a tubular module of the first discontinuous layer of said second adjacent electrochemical cell is a direct contact.

11. The Tubular electrochemical separation unit according to claim 8, wherein said tubular electrochemical separation unit comprises at least five said electrochemical cells.

12. The Tubular electrochemical separation unit according to claim 8, wherein a space between two successive tubular modules of the first discontinuous layer is filled with a tubular module of the second discontinuous layer.

13. The Tubular electrochemical separation unit according to claim 8, wherein a space between two successive tubular modules of the second discontinuous layer is filled with a tubular module of the third discontinuous layer.

14. The Tubular electrochemical separation unit according to claim 8, wherein the first discontinuous layer and the third discontinuous layer are electrodes.

15. The Tubular electrochemical separation unit according to claim 8, wherein the first discontinuous layer is an internal electrode.

16. The Tubular electrochemical separation unit according to claim 8, wherein the second discontinuous layer is an electrochemical separation membrane.

17. The Tubular electrochemical separation unit according to claim 8, wherein the third discontinuous layer is an external electrode.

18. Use of a tubular electrochemical separation unit according to the claim 8 for electrochemical separation of molecular species.

19. System for producing the tubular electrochemical separation unit according to the claim 8, wherein said system comprises:
Means of transport configured to forward at least one layer, said means of transport being arranged in order to carry out a rotational movement,
Means of deposition configured to achieve a tubular continuous or a tubular discontinuous deposit of each layer, and
Means for heating configured to heat each layer according to a predetermined and controlled time-temperature.
